(19) United States
(12) Patent Application Publication
(10) Pub. No.: US 2012/0296871 A1
(43) Pub. Date: Nov. 22, 2012

(54) FILE MANAGING APPARATUS FOR PROCESSING AN ONLINE STORAGE SERVICE

(75) Inventor: Satoru GOTO, Nagoya-shi (JP)

(73) Assignee: Buffalo Inc., Nagoya-shi (JP)

(21) Appl. No.: 13/475,381

(22) Filed: May 18, 2012

(30) Foreign Application Priority Data
May 19, 2011 (JP) 2011-112923

(51) Int. Cl. G06F 17/30; G06F 15/16

(52) U.S. Cl. 707/626; 707/E17.032

(57) ABSTRACT

A file managing apparatus that controls uploading a target file to an online storage by dividing the target file into a plurality of divided files when a file size of the target file to be uploaded to the online storage exceeds a maximum size per one file permitted in the online storage; manages identification information related to the plurality of divided files by associating the identification information with the target file; and restores the target file by combining the plurality of divided files after having downloaded the plurality of divided files from the online storage based on the managed identification information.

### CROSS REFERENCE TO RELATED APPLICATIONS

The present application claims priority to Japanese Patent Application No. 2011-112923 filed on May 19, 2011, the disclosure of which is hereby incorporated by reference in its entirety.

### BACKGROUND OF THE DISCLOSURE

1. Field of the Disclosure

The present disclosure relates to a file managing apparatus capable of processing an online storage service and a non-transitory computer readable storage medium storing a control program for processing an online storage service.

2. Description of the Related Art

Conventionally, in order to store various types of files, a local storage such as a storage device provided in a terminal apparatus of a user (hereafter referred to as “user terminal”), a storage device connected to the user terminal and the like is used.

In the recent years, an online service (web service) that can store files in an online storage provided on the Internet is being offered accompanying a development of communication technology. In such a service, the user terminal performs uploads and downloads of files to and from the online storage.

Further, to improve convenience of the online storage, a file managing apparatus that offers a use experience that does not give a sense of presence of the online storage despite the fact of actually using the online storage is being proposed (see Japanese Patent Application Laid-Open No. 2010-287104).

The file managing apparatus described in Japanese Patent Application Laid-Open No. 2010-287104 includes an application for automatically uploading to an online storage files that were stored or updated to the apparatus itself. A virtual file is displayed to the user for feigning as if the files in the online storage are within the apparatus itself.

In some cases, a utilization restriction is set to the online storage by a service provider so as to avoid abuse and excessive monopolization of the service by certain users.

Accordingly, in a configuration such as the file managing apparatus described in Japanese Patent Application Laid-Open No. 2010-287104 treating the online storage similar to a local storage, when an access to the online storage becomes unavailable due to the aforesaid utilization restriction, there had been a problem that storing and reading files become unavailable.

Thus, the present disclosure is directed to a file managing apparatus capable of appropriately performing storing and reading the files even in the case where the utilization restriction is set to the online storage by the service provider.

### SUMMARY OF THE DISCLOSURE

The present disclosure is directed to a file managing apparatus that controls uploading a target file to an online storage by dividing the target file into a plurality of divided files when a file size of the target file to be uploaded to the online storage exceeds a maximum size per one file permitted in the online storage; manages identification information related to the plurality of divided files by associating the identification information with the target file; and restores the target file by combining the plurality of divided files after having downloaded the plurality of divided files from the online storage based on the managed identification information.

### BRIEF DESCRIPTION OF THE DRAWING

FIG. 1 is an overall configuration drawing of a communication system according to the present disclosure;

FIG. 2 is a hardware configuration diagram of a NAS of according to the present disclosure;

FIG. 3 is a software configuration diagram of the NAS according to the present disclosure;

FIG. 4 is a diagram showing a specific example of a directory configuration according to the present disclosure;

FIG. 5 is an operational sequence diagram upon uploading a storage target file while being divided; and

FIG. 6 is an operational sequence diagram upon downloading the file uploaded while being divided.

### DETAILED DESCRIPTION OF EMBODIMENTS

The present disclosure will be explained with reference to the drawings. The present disclosure adapts an NAS (Network Attached Storage), for example, as the file managing apparatus. In the drawings of the disclosure hereafter, identical or similar reference signs are given to identical or similar components.

(System Configuration)

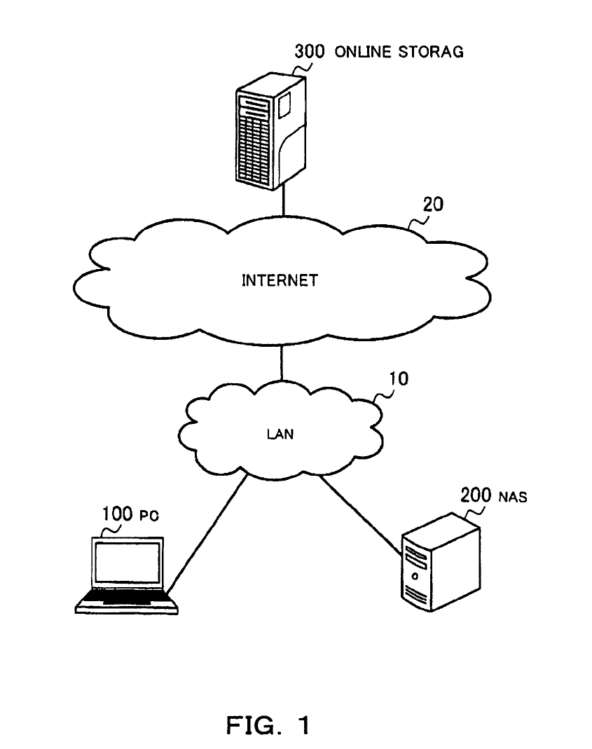

First, an overall configuration of the communication system will be explained. FIG. 1 is an overall configuration drawing of an exemplary communication system 1 according to the present disclosure.

As shown in FIG. 1, the communication system 1 includes a PC (personal computer) 100, a NAS 200 and an online storage 300. The PC 100 corresponds to a user terminal. Alternatively, instead of the PC 100, a cell phone terminal, a network compatible television receiver and the like may be adapted as the user terminal.

The PC 100 and the NAS 200 are connected to a LAN (Local Area Network) 10 such as an in-house network and are capable of communicating with one another through the LAN 10. The LAN 10 is connected to the Internet 20 through a router and the like. The online storage 300 is connected to the Internet 20.

The PC 100 is an information processing apparatus that is operated by a user, and is furnished with a network communicating function for performing network communication and a user I/F (display, keyboard, mouse and the like). The PC 100 stores and reads files to and from the NAS 200 through the LAN 10.

The NAS 200 is a file server specialized in file storage and management, and is furnished with a file system for performing the file management and the network communicating function for performing the network communication. The NAS 200 may be shared by a plurality of user terminals.

The online storage 300 provides a web service capable of storing files, and is configured of one or more file servers. For example, the online storage 300 provides a storage area which the user can utilize by the user of the PC 100 registering to the web server. In the present disclosure, it is assumed that the user of the PC 100 has already registered to the service provided by the online storage 300.

Further, a utilization restriction is set to the online storage 300 by a service provider. In the present embodiment, the utilization restriction means that a permissible maximum size is set for a file size of one file. The permissible maximum size is a maximum size of the file size per one file of which the online storage 300 allows storage of, and is for example up to 1 GB per one file or up to 2 GB per one file.

Further, as another utilization restriction, there may be a case in which an upper limit value is set for a number of access per unit time. The upper limit value of the number of access per unit time is for example an upper limit value of 300 times per one hour. Note that, the number of access to the online storage 300 corresponds to a number of the NAS 200 calling an API (Application Program Interface) provided in the online storage 300.

(Configuration of NAS)

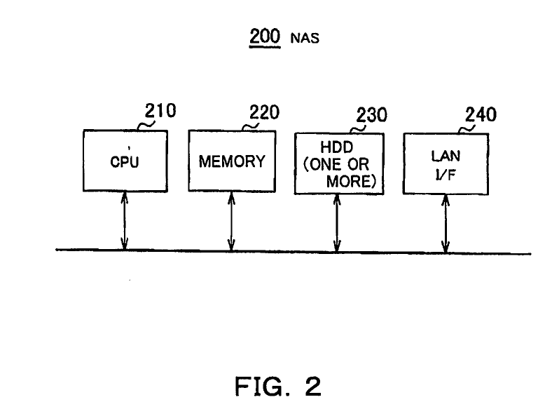

Next, a hardware configuration of the NAS 200 will be explained. FIG. 2 is a hardware configuration diagram of the NAS 200.

As shown in FIG. 2, the NAS 200 includes a CPU (Central Processing Unit) 210, memory 220, one or more HDDs (Hard Disk Drive) 230, and the LAN I/F 240. The CPU 210, the memory 220, the HDD 230 and the LAN I/F 240 are connected to one another through a bus line.

The CPU 210 controls the respective functions of the NAS 200 by executing a control program (firmware) stored in the memory 220.

The memory 220 includes flash memory and RAM (Random Access Memory). The flash memory stores the control program to be executed by the CPU 210. The RAM temporarily stores the control program read from the flash memory and is used as a work area of the CPU 210.

The memory 220 may include a cache area for caching files to be uploaded to the online storage 300 and files downloaded from the online storage 300. Further, the memory 220 stores contents of the utilization restriction (which is in the present embodiment the permissible maximum size per one file and the upper limit value of the number of access per unit time) for the online storage 300.

The HDI) 230 stores the respective files. The HDD 230 may be configured as a disk array, and may configure RAID (Redundant Arrays of Inexpensive Disks).

The LAN I/F 240 is connected to the LAN 10, and is configured to communicate through the LAN 10. The LAN I/F 240 may be wiredly connected to the LAN 10, and may be wirelessly connected to the LAN 10. In the present embodiment, the LAN I/F 240 corresponds to a receiving section that receives a file storing request, a storage target file, a file updating request, a file reading request and the like from the PC 100.

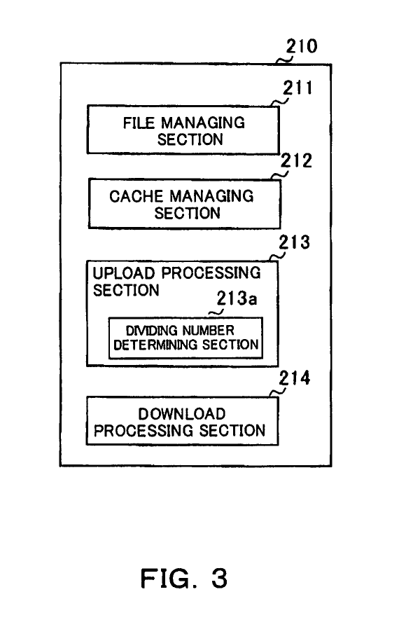

Next, a software configuration of the NAS 200 will be explained. FIG. 3 is a software configuration diagram of the NAS 200.

As shown in FIG. 3, the CPU 210 configures the respective function sections of a file managing section 211, a cache managing section 212, an upload processing section 213 and a download processing section 214 by executing the control program stored by the memory 220.

The file managing section 211 corresponds to a file system. In the present disclosure, the file managing section 211 performs file management by the directory configuration in which a virtual local directory indicating the online storage 300 is arranged as a lower directory of a directory indicating the NAS 200. By accessing the NAS 200, the PC 100 can browse through the directory configuration and perform file operation to the aforementioned directory configuration. A specific example of the aforementioned directory configuration will be explained later.

Thus, an entity of the file to be managed by the virtual local directory exists in the online storage 300. Due to this, when the file storing request is made to the virtual local directory, as will be explained later, a storage target file needs to be uploaded to the online storage 300. Below, a configuration of uploading the storage target file to the online storage 300 in response to the file storing request to the virtual local directory will be explained.

The cache managing section 212 caches the storage target file in the cache area provided in the memory 220. Further, the cache managing section 212 updates the cached storage target file in response to the file updating request from the PC 100.

The upload processing section 213 and the download processing section 214 correspond to an API provided in relation to the online storage 300. Note that, it is assumed that information necessary for the upload processing section 213 and the download processing section 214 to access the online storage 300 (for example, address information and authentication information) is preliminarily stored in the memory 220.

The upload processing section 213 uploads the storage target file cached by the cache managing section 212 to the online storage 300. Note that, it is assumed that information necessary for the upload processing section 213 to upload to the online storage 300 (for example, address information and authentication information) is preliminarily stored in the memory 220.

Upon the upload of the storage target file, the upload processing section 213 checks whether a file size of the storage target file exceeds the permissible maximum size of the online storage 300. Then, if the file size of the storage target file exceeds the permissible maximum size of the online storage 300, the upload processing section 213 uploads to the online storage 300 the storage target file by dividing it into a plurality of divided files.

Further, the upload processing section 213 includes the dividing number determining section 213a that determines the dividing number of the storage target file based on the file size of the storage target file and the permissible maximum size of the online storage 300. The dividing number determining section 213a determines the dividing number of the storage target file such that a file size of each of the plurality of divided files becomes at or less than the maximum size. For example, if the permissible maximum size of the online storage 300 is 1 GB and the file size of the storage target file is 3 GB, it would suffice to divide the storage target file into three or more.

Further, if the upper limit value is set for the number of access to the online storage 300 per unit time, the dividing number determining section 213a monitors the number of access to the online storage 300 per unit time (that is, the number of calling the API) by the upload processing section 213 and the download processing section 214. Then, the dividing number determining section 213a determines the dividing number of the storage target file such that the file size of each of the plurality of divided files is at or less than the permissible maximum size of the online storage 300 and that the number of access to the online storage 300 per unit time does not exceed the upper limit value. For example, as the number of access to the online storage 300 per unit time by the upload processing section 213 and the download processing section 214 increases closer to the upper limit value, the number of access is suppressed by making the dividing number of the storage target file smaller.

In uploading the storage target file by dividing the same, the file managing section 211 gives IDs (file names) to the plurality of divided files obtained by dividing the storage target file, and manages the IDs in association with the storage target file. Note that, when the PC 100 browses through the directory configuration of the NAS 200, the file managing section 211 displays an ID (file name) of the storage target file associated with the IDs of the respective divided files without displaying the IDs of the respective divided files.

According to this, display control can be made such that the user not to be aware of the fact that the actual file is divided.

In a case where the LAN I/F 240 receives a read request from the PC 100, where the aforementioned read request targets the virtual local directory, the download processing section 214 checks whether a read target file according to the read request is stored while being divided or not based on information managed by the file managing section 211. Then, if the read target file is stored in the divided manner, the download processing section 214 downloads the plurality of divided files corresponding to the read target file from the online storage 300 based on the information managed by the file managing section 211, thereafter restores the read target file by combining the aforementioned divided files, and transfers the aforementioned restored read target file to the PC 100.

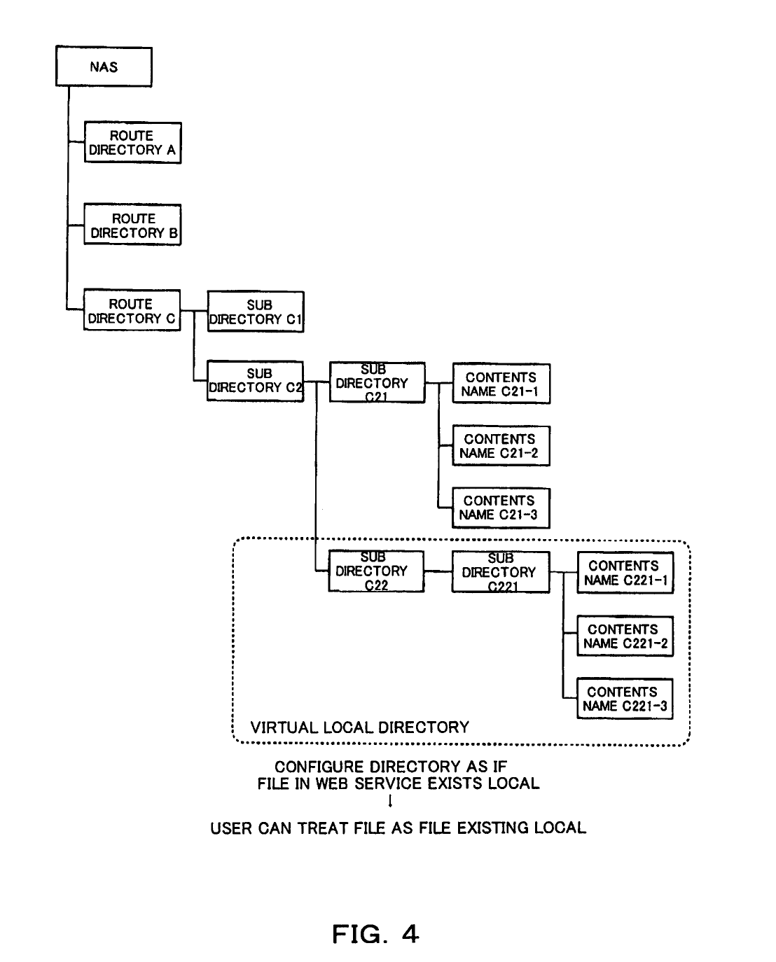

Next, a specific example of the directory configuration managed by the file managing section 211 will be explained. FIG. 4 is a diagram showing the specific example of the directory configuration managed by the file managing section 211.

As shown in FIG. 4, the aforementioned directory configuration includes route directories A to C indicating the NAS 200, includes sub directories C1 and C2 as lower directories of the route directory C, and includes sub directories C21 and C22 as lower directories of the sub directory C2.

An entity of each file (contents C21-1 to C21-3) included in the sub directory C21 is stored in the NAS 200. Contrary to this, an entity of each file (contents C221-1 to C221-3) included in (the sub directory C221 of) the sub directory C22 is stored in the online storage 300.

Accordingly, although the directories under the sub directory C22 are dealt as if the files exist in the NAS 200, the entities of the aforementioned files exist in the online storage 300, and thus are configured as virtual local directories.

Note that, such virtual local directory can be configured for example by using a FUSE (Filesystem in Userspace) that is one of software capable of constituting a file system.

(Operation of NAS)

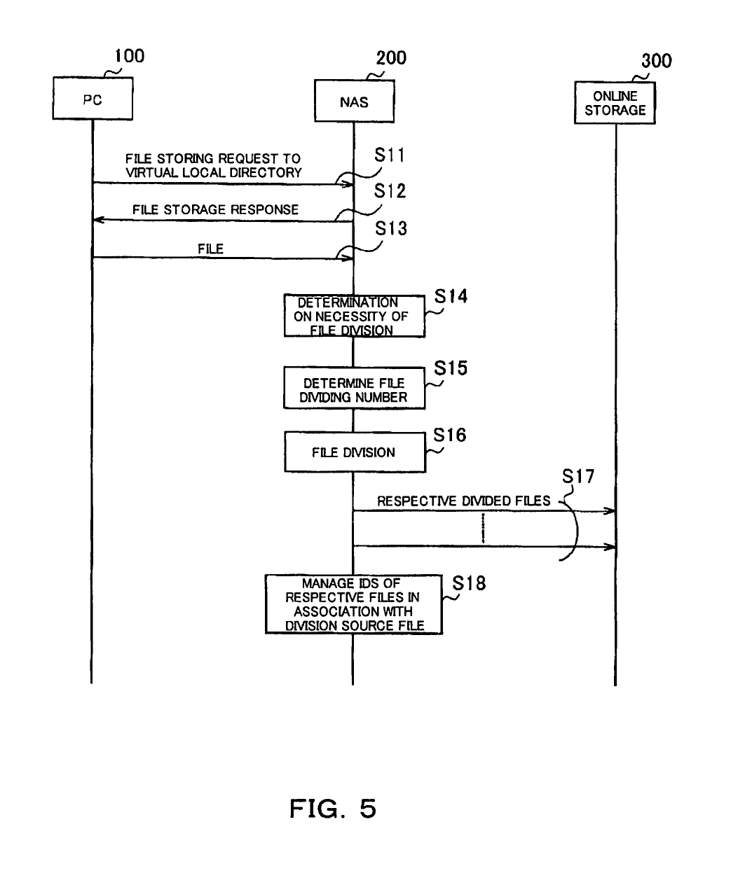

Next, an operation upon dividing the storage target file and uploading the same will be explained. FIG. 5 is an operational sequence diagram upon uploading the storage target file by dividing the same.

As shown in FIG. 5, in step S11, the PC 100 sends to the NAS 200 the file storing request to the aforementioned virtual local directory based on the directory configuration managed by the NAS 200. The NAS 200 receives the aforementioned file storing request.

In step S12, the NAS 200 sends to the PC 100 a positive response to the file storing request. The PC 100 receives the aforementioned positive response.

In step S13, the PC 100 transfers to the NAS 200 the storage target file corresponding to the file storing request. The NAS 200 receives and caches the aforementioned storage target file.

Note that, the NAS 200 specifies the file size of the storage target file from information received in step S11 or S13.

In step S 14, the NAS 200 checks whether the file size of the storage target file exceeds the permissible maximum size of the online storage 300. Here, it is assumed that the file size of the storage target file exceeds the permissible maximum size of the online storage 300, and it is determined that the division of the storage target file is necessary.

In step S15, the NAS 200 determines the dividing number of the storage target file such that the file size of each of the plurality of divided files is at or less than the maximum size based on the file size of the storage target file and the permissible maximum size of the online storage 300. Note that, in the case where the upper limit value is set for the number of access to the online storage 300 per unit time, the NAS 200 determines the dividing number of the storage target file such that the file size of each of the plurality of divided files is at or less than the permissible maximum size of the online storage 300 and that the number of access to the online storage 300 per unit time does not exceed the upper limit value.

In step S16, the NAS 200 divides the cached storage target file in accordance with the dividing number determined in step S15. At this occasion, the NAS 200 gives the IDs (file names) to the plurality of divided files obtained by dividing the storage target file. For example, IDs such as a divided file #1, a divided file #2, and so on are given.

In step S17, the NAS 200 uploads the respective ones of the plurality of divided files obtained in step S16 to the online storage 300.

In step S18, the NAS 200 manages the IDs of the respective files in association with the storage target file. For example, a table in which a group composed of the IDs of the respective divided files is associated with the ID (file name) of the storage target file is created and stored in the memory 220.

Note that, when the PC 100 browses through the directory configuration of the NAS 200, the NAS 200 displays the ID (file name) of the storage target file associated with the IDs of the respective divided files without displaying the IDs of the respective divided files.

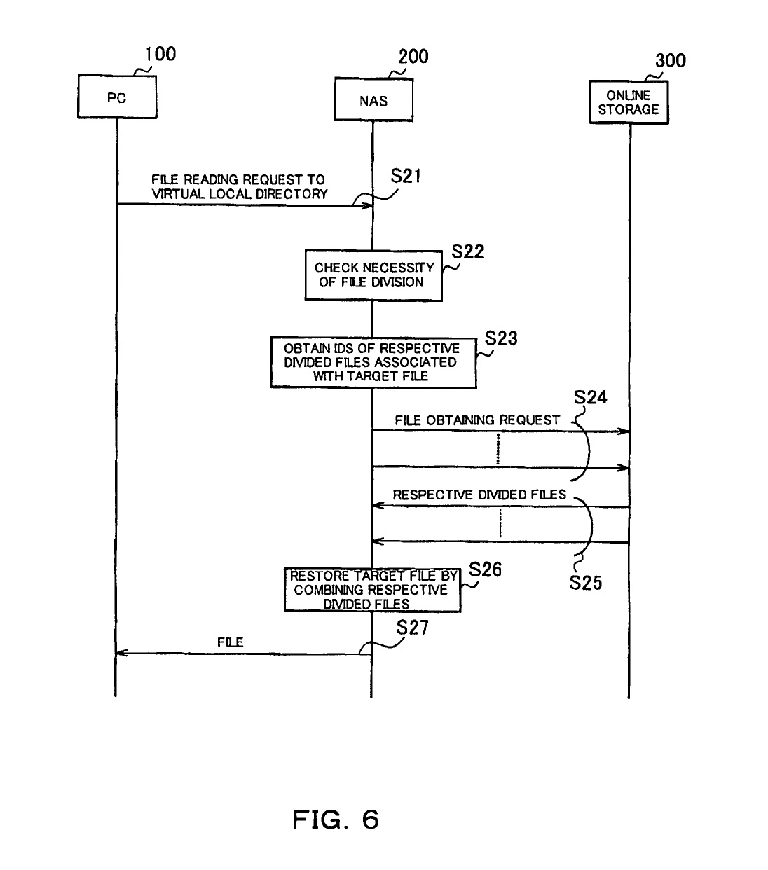

Next, an operation upon downloading the file that had been uploaded while being divided will be explained. FIG. 6 is an operational sequence diagram upon downloading the file uploaded while being divided.

As shown in FIG. 6, the PC 100 sends to the NAS 200 the file reading request to the aforementioned virtual local directory based on the directory configuration managed by the NAS 200. The NAS 200 receives the aforementioned file reading request. The aforementioned file reading request includes an ID (file name) of the read target file.

In step S22, the NAS 200 checks whether the read target file is a file uploaded while being divided or not based on the file reading request received from the PC 100. For example, if the group of the IDs of the divided files is associated with the ID of the read target file included in the aforementioned file reading request, it is determined that the aforementioned read target file is a file that has been uploaded while being divided. Here, it is assumed that a determination has been made that the aforementioned read target file is a file that had been uploaded while being divided.

In step S23, the NAS 200 obtains the IDs of the respective divided files associated with the ID of the read target file included in the aforementioned file reading request based on the table stored in the memory 220.

In step S24, the NAS 200 sends to the online storage 300 a file obtaining request for each of the IDs of the divided files obtained in step S23. The online storage 300 receives the file obtaining request for each of the IDs of the divided files.

In step S25, the online storage 300 transfers to the NAS 200 each of the divided file indicated by the IDs of the divided files based on the file obtaining request for each of the IDs of the divided files received in step S24. The NAS 200 receives the respective divided files from the online storage 300.

In step S26, when it has been confirmed that all of the divided files associated with the ID of the read target file have been received, the NAS 200 restores the read target file by combining these divided files in order based on the IDs.

In step S27, the NAS 200 transfers the read target file restored in step S26 to the PC 100. The PC 100 receives the read target file from the NAS 200.

(Effects)

As explained above, the NAS 200 of the present disclosure can upload the target file to the online storage 300 even when the file size of the target file to be uploaded to the online storage 300 exceeds the maximum size allowed for one file in the online storage 300 (utilization restriction). Further, by managing the identification information of the plurality of divided files in association with the target file, the target file can be restored based on the aforementioned managed identification information.

Further, in the present disclosure, since the dividing number of the storage target file is determined such that the respective file sizes of the plurality of divided files become at or less than the maximum size, the target file can more surely be uploaded to the online storage 300.

Further, in the present disclosure, since the dividing number is determined so that the number of access to the online storage 300 per unit time does not exceed the upper limit value, the aforementioned target file can more surely be uploaded to the online storage 300 even in if the upper limit value (utilization restriction) is set to the number of access to the online storage 300 per unit time.

In the present disclosure, the online storage 300 can be treated similar to a local storage by changing the directory configuration, and storing and reading the file can appropriately be performed even if the utilization restriction is set for the online storage 300 by the service provider.

(Modifications)

Further, it should be understood that statements and drawings do not restrict this disclosure. From this disclosure, various alternative embodiments, examples and application techniques will be obvious to those skilled in the art.

For example, although the NAS 200 is used as the file managing apparatus, the PC 100 may be used as the file managing apparatus instead of the NAS 200. In this case, the PC 100 includes similar configurations as the hardware configuration shown in FIG. 2 and the software configuration shown in FIG. 3.

Accordingly, it should be understood that the present disclosure covers various embodiments and the like that are not described herein.

What is claimed is:

1. A file managing apparatus comprising:
a processor that:
controls uploading a target file to an online storage by dividing the target file into a plurality of divided files when a file size of the target file to be uploaded to the online storage exceeds a maximum size per one file permitted in the online storage;
manages identification information related to the plurality of divided files by associating the identification information with the target file; and
restores the target file by combining the plurality of divided files after having downloaded the plurality of divided files from the online storage based on the managed identification information.

2. The file managing apparatus according to claim 1, wherein
the processor determines a dividing number of the target file based on the file size of the target file and the maximum size.

3. The file managing apparatus according to claim 2, wherein
the processor determines the dividing number such that a file size of each of the plurality of divided files is equal to or less than the maximum size.

4. The file managing apparatus according to claim 3, wherein
the processor determines, when an upper limit value for a number of access to the online storage per unit time is set, the dividing number such that the file size of each of the plurality of divided files is equal to or less than the maximum size and a number of accesses to the online storage per unit time does not exceed the upper limit value.

5. The file managing apparatus according to claim 1, further comprising:
a communication interface that receives the target file from a user terminal through a network, wherein
the processor, when a file size of the target file received by the communication interface exceeds the maximum size, controls uploading the target file to the online storage by dividing the target file into the plurality of divided files.

6. The file managing apparatus according to claim 1, further comprising:
a communication interface that receives a read request for the target file from a user terminal through a network, wherein
the processor restores, when the communication interface receives the read request, the target file by combining the plurality of divided files, and controls transferring the restored target file to the user terminal through the communication interface after having downloaded the plurality of divided files from the online storage based on the managed identification information.

7. The file managing apparatus according to claim 1, wherein
the processor:
performs file management by a directory configuration in which a virtual local directory indicating the online storage is arranged as a lower directory of a directory indicating the file managing apparatus; and
controls uploading the target file to the online storage by dividing the target file into the plurality of divided files when a storing request is made for the target file to the virtual local directory and a file size of the target file exceeds the maximum size.

8. A non-transitory computer readable storage medium including a program, which when executed by a computer, causes the computer to perform a file managing process, the file managing process comprising:
uploading a target file to an online storage by dividing the target file into a plurality of divided files when a file size of the target file to be uploaded to the online storage exceeds a maximum size per one file permitted in the online storage;
managing identification information related to the plurality of divided files by associating the identification information with the target file; and
restoring the target file by combining the plurality of divided files after having downloaded the plurality of divided files from the online storage based on the managed identification information.

9. The non-transitory computer readable storage medium according to claim 7, the file managing process further comprising:
determining a dividing number of the target file based on the file size of the target file and the maximum size.

10. The non-transitory computer readable storage medium according to claim 9, wherein
the determining includes determining the dividing number such that a file size of each of the plurality of divided files is equal to or less than the maximum size.

11. The non-transitory computer readable storage medium according to claim 10, wherein
the determining includes determining, in a case where an upper limit value for a number of access to the online storage per unit time is set, the dividing number such that the file size of each of the plurality of divided files is equal to or less than the maximum size and the number of access to the online storage per unit time does not exceed the upper limit value.

12. The non-transitory computer readable storage medium according to claim 8, the file managing process further comprising:
receiving the target file from a user terminal through a network, wherein
the uploading includes uploading the target file to the online storage by dividing it into the plurality of divided files when a file size of the received target file exceeds the maximum size.

13. The non-transitory computer readable storage medium according to claim 8, the file managing process further comprising:
receiving a read request for the target file from a user terminal through a network, wherein
the restoring includes restoring the target file by combining the plurality of divided files and transferring the restored target file to the user terminal through the network after having downloaded the plurality of divided files from the online storage based on the managed identification information.

14. The non-transitory computer readable storage medium according to claim 8, the file managing process further comprising:
performing file management by a directory configuration in which a virtual local directory indicating the online storage is arranged as a lower directory of a directory indicating the computer, wherein
the uploading includes uploading the target file to the online storage by dividing the target file into the plurality of divided files when a storing request is made for the target file to the virtual local directory and a file size of the target file exceeds the maximum size.

15. A file managing method performed by a file managing apparatus, the file managing method comprising:
uploading, by a processor of the file managing apparatus, a target file to an online storage by dividing the target file into a plurality of divided files when a file size of the target file to be uploaded to the online storage exceeds a maximum size per one file permitted in the online storage;
managing, by the processor, identification information related to the plurality of divided files by associating the identification information with the target file; and
restoring, by the processor, the target file by combining the plurality of divided files after having downloaded the plurality of divided files from the online storage based on the managed identification information.
